(19) United States
(12) Patent Application Publication
(10) Pub. No.: US 2026/0361916 A1
(43) Pub. Date: Nov. 12, 2026

(54) METHOD AND APPARATUS FOR VIDEO CODING BASED ON NON-SEPARABLE SECONDARY TRANSFORM ADAPTIVE TO PRIMARY TRANSFORM KERNEL

(71) Applicants: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(72) Inventors: Dong Gyu Sim, Seoul (KR); Joo Hyung Byeon, Seoul (KR); Min Hun Lee, Uijeongbu-si (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(21) Appl. No.: 19/104,088

(22) PCT Filed: Jul. 28, 2023
(86) PCT No.: PCT/KR2023/011041

§ 371 Date: Feb. 14, 2025

(30) Foreign Application Priority Data
Aug. 29, 2022 (KR) 10-2022-0108550
Jul. 26, 2023 (KR) 10-2023-0097617

(51) Int. Cl. H04N 19/60; H04N 19/103; H04N 19/129; H04N 19/159; H04N 19/176; H04N 19/18; H04N 19/593

(52) U.S. Cl. CPC H04N 19/60; H04N 19/103; H04N 19/129; H04N 19/159; H04N 19/176; H04N 19/18; H04N 19/593

(57) ABSTRACT

A method and an apparatus are disclosed for video coding based on non-separable secondary transform adaptive to a primary transform kernel. In the disclosed embodiments, a video decoding device determines primary inverse transform kernels in vertical and horizontal directions with respect to a transform block of the current block. The video decoding device obtains dequantized secondary transform coefficients for the transform block. The video decoding device determines a secondary inverse transform kernel of the transform block based on a size of the transform block an intra-prediction mode of the current block, and the primary inverse transform kernel. The video decoding generates primary transform coefficients by applying the secondary inverse transform kernel to the secondary transform coefficients and generates residual signals by applying the primary inverse transform kernels to the primary transform coefficients.

### TECHNICAL FIELD

The present disclosure relates to a video coding method and an apparatus based on non-separable secondary transform adaptive to a primary transform kernel.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Low-frequency non-separable transform (LFNST) technique performs a secondary transform on a low-frequency region among the transform coefficients generated by the primary transform of a transform block or transform unit (TU) during intra prediction. The LFNST technology performs a secondary transform on L low-frequency primary transform coefficients among W×H primary transform coefficients to generate K secondary transform coefficients (where K≤L). The encoding device may quantize and then encode the generated secondary transform coefficients. The transform kernel has a size K×L in the LFNST, and the type of the kernel may be determined according to the intra-prediction mode of the current TU, the size of the TU, and LFNST index of lfnst_idx.

Meanwhile, when a DCT2/DCT2 transform kernel is applied as the primary transform for an intra-predicted TU, the LFNST may be applied. Therefore, to increase the video coding efficiency and enhance the video quality, there is a need to consider further utilizing the characteristics of the primary transform when applying the secondary transform.

### DISCLOSURE

### Technical Problem

The present disclosure seeks to provide a video coding method and an apparatus that select, by reflecting characteristics of a primary transform kernel, a secondary transform region and a transform kernel The video coding method and the apparatus use the selected transform kernel to apply a non-separable secondary transform to the transform coefficients in a low-frequency region.

### Technical Solution

At least one aspect of the present disclosure provides a method of reconstructing a current block by a video decoding device. The method includes determining primary inverse transform kernels in vertical and horizontal directions with respect to a transform block of the current block. The method also includes obtaining dequantized secondary transform coefficients for the transform block. The method also includes determining a secondary inverse transform kernel of the transform block based on a size of the transform block, an intra-prediction mode of the current block, and the primary inverse transform kernel. The method also includes performing a secondary inverse transform by generating primary transform coefficients by applying the secondary inverse transform kernel to the secondary transform coefficients. The method also includes performing a primary inverse transform by generating residual signals by applying the primary inverse transform kernels to the primary transform coefficients.

Another aspect of the present disclosure provides a method of encoding a current block by a video encoding device. The method includes obtaining residual signals with respect to a transform block of the current block. The method also includes determining a primary transform kernel in vertical and horizontal directions with respect to the transform block. The method also includes determining a secondary transform kernel of the transform block based on a size of the transform block, an intra-prediction mode of the current block, and the primary inverse transform kernel. The method also includes performing a primary transform by generating primary transform coefficients by applying the primary transform kernel to the residual signals. The method also includes and performing a secondary transform by generating secondary transform coefficients by applying the secondary transform kernel to the primary transform coefficients.

Yet another aspect of the present disclosure provides a computer-readable recording medium storing a bitstream generated by a video encoding method. The video encoding method includes obtaining residual signals with respect to a transform block of a current block. The video encoding method also includes determining a primary transform kernel in vertical and horizontal directions with respect to the transform block. The video encoding method also includes determining a secondary transform kernel of the transform block based on a size of the transform block, an intra-prediction mode of the current block, and the primary inverse transform kernel. The video encoding method also includes performing a primary transform by generating primary transform coefficients by applying the primary transform kernel to the residual signals. The video encoding method also includes performing a secondary transform by generating secondary transform coefficients by applying the secondary transform kernel to the primary transform coefficients.

### Advantageous Effects

As described above, the present disclosure provides a video coding method and an apparatus that select, by reflecting characteristics of a primary transform kernel, a secondary transform region and a transform kernel. The video coding method and the apparatus use the selected transform kernel to apply a non-separable secondary transform to the transform coefficients in a low-frequency region. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a block diagram detailing a portion of a video decoding device, according to at least one embodiment of the present disclosure.

FIGS. 7A through 7C are diagrams illustrating scanning sequences of two-dimensional transform coefficients, according to some embodiments of the present disclosure.

FIGS. 8A and 8B are diagrams illustrating scanning sequences of one-dimensional transform coefficients, according to some embodiments of the present disclosure.

FIG. 9 is a diagram illustrating scanning positions of one-dimensional transform coefficients, according to at least one embodiment of the present disclosure.

FIG. 10 is a diagram illustrating a scanning sequence of one-dimensional transform coefficients, according to another embodiment of the present disclosure.

FIG. 11 is a flowchart of a method of transforming a transform block by a video encoding device, according to another embodiment of the present disclosure.

FIG. 12 is a flowchart of a method of inversely transforming a transform block by a video decoding device, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

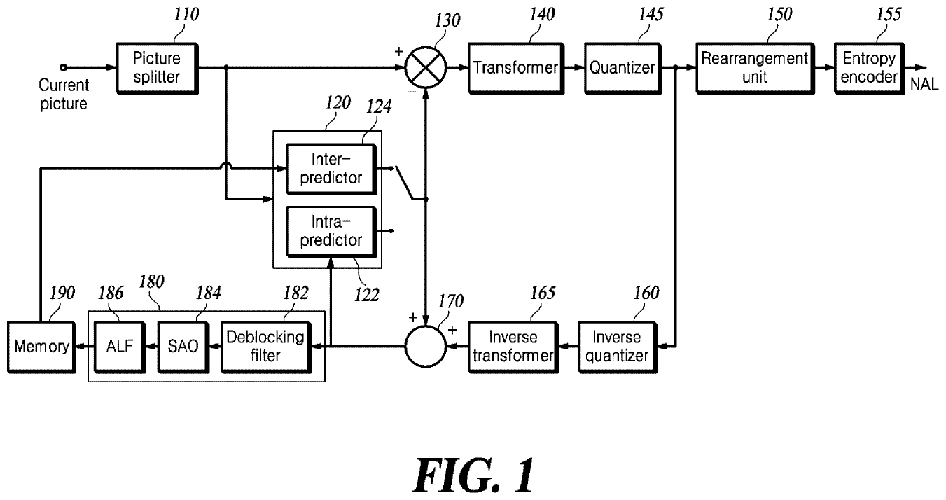

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

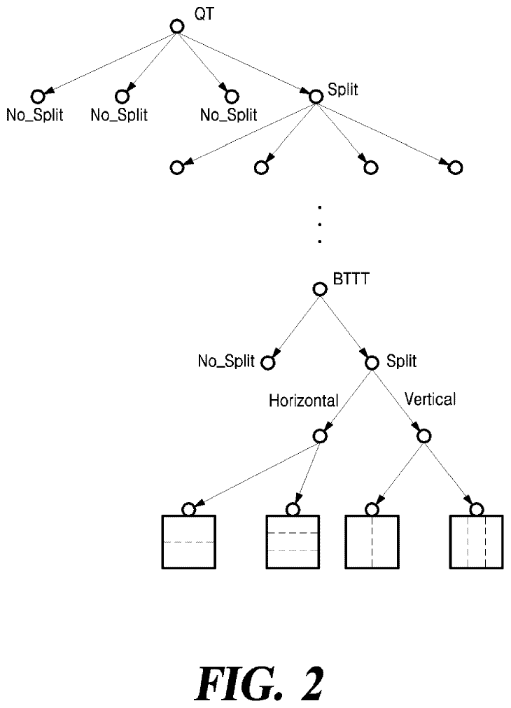

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

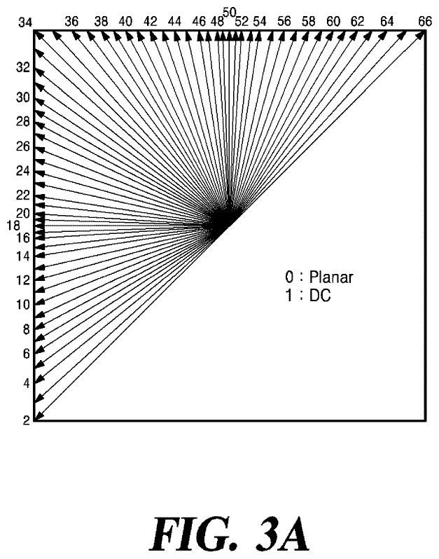

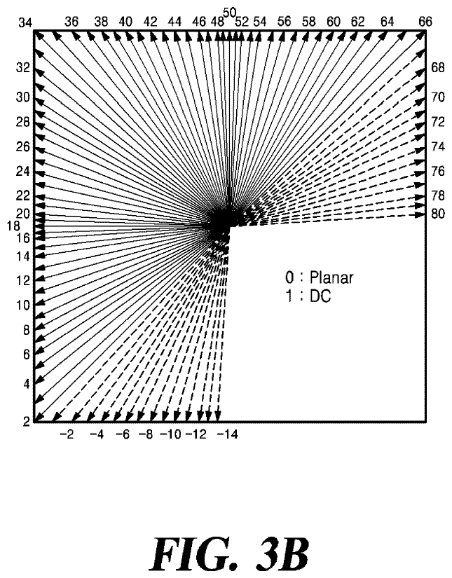

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

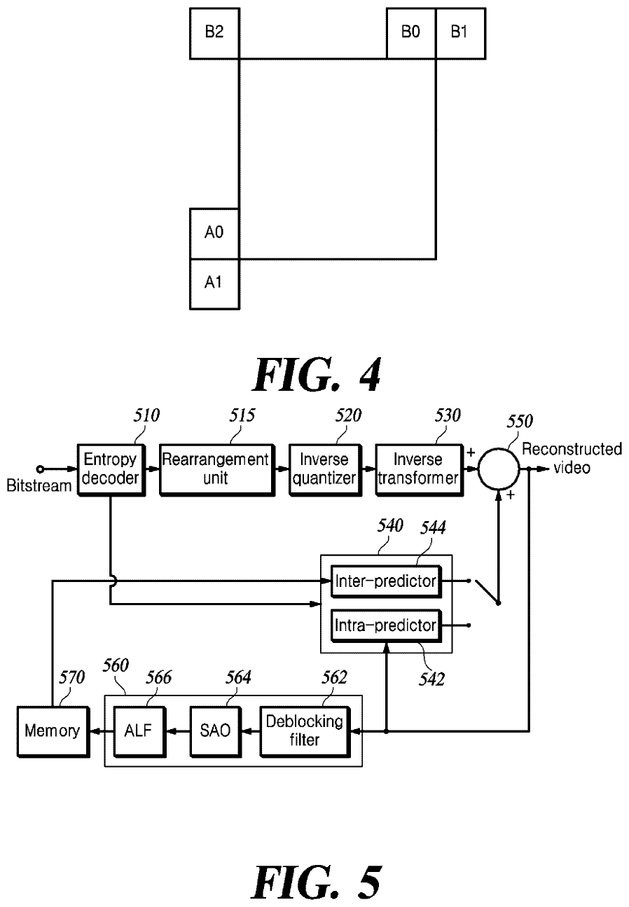

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus for selecting, by reflecting characteristics of a primary transform kernel, a secondary transform region and a transform kernel. The video coding method and the apparatus use the selected transform kernel to apply a non-separable secondary transform to the transform coefficients in a low-frequency region.

The following embodiments may be performed by the transformer 140 and the inverse transformer 165 in the video encoding device. The following embodiments may also be performed by the inverse transformer 530 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. TRANSFORM TECHNIQUES—PRIMARY TRANSFORM TECHNIQUES

As described above, for efficient video compression, quantization or scaling may be further applied to the residual signals remained after prediction according to various prediction techniques. In this case, based on the significance of the perceptual visual information inherent in the residual signals, a transform technique may be applied to cluster the residual signals according to their frequency components, and then scaling may be performed. However, for non-natural signals such as screen contents, this frequency-based transform may be inefficient. In such cases, the transform technique may be omitted and only scaling may be performed, or encoding/decoding may be performed without applying scaling.

In HEVC, when transforms are applied, DCT-II is used as a transform kernel (hereinafter, used interchangeably with a transform type) for transforming the residual signals. However, to apply a more appropriate transform technique to the diversity of residual signal characteristics, Multiple Transform Selection (MTS) may be used. MTS determines the optimal one or two of the multiple transform types and then transforms the blocks according to the determined transform type. For example, in VVC (Versatile Video Coding), in addition to DCT-II, two other transform types, DCT-VIII and DST-VII, are added, as shown in Table 1, to allow the residual signals to be transformed in different ways.

TABLE 1

| Transform Type | Basis function Tᵢ(j), i, j = 0, 1, ... , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} ) where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

Here, the basis functions form a transform matrix that defines each transform type. Hereinafter, DCT-II, DCT-VIII, and DST-VII are used interchangeably with DCT2, DCT8, and DST7, respectively.

Meanwhile, the flag that determines whether or not MTS (Multiple Transform Selection) is to be used or enabled may be controlled on a block-by-block basis. In addition, the use or nonuse of MTS may be controlled by using an enable flag at a higher SPS level.

When MTS at the SPS is enabled, a CU-level flag may be expressed to indicate whether MTS is applied. Here, MTS may be used for the luma component. The CU level flag may be expressed if both the width and height of the TB are less than or equal to 32 pixels and if the Coded Block Flag (CBF), indicating whether any of the transform coefficient levels have non-zero values, is true.

If the CU level flag is 0, the DCT2 is utilized for kernels in both the horizontal and vertical directions. On the other hand, if the CU level flag is non-zero, MTS is applied. MTS may be utilized in two ways of explicit MTS and implicit MTS.

In the explicit MTS, the kernel used for the TB is explicitly transmitted. Typically, the index of the transform kernel may be transmitted. For example, mts_idx, the index of the kernel, may be defined as shown in Table 2.

TABLE 2

| mts_idx | 0 | 1 | 2 | 3 | 4 |
|---|---|---|---|---|---|
| trTypeHor | 0 | 1 | 2 | 1 | 2 |
| trTypeVer | 0 | 1 | 1 | 2 | 2 |

Here, trTypeHor and trTypeVer represent the transform type in the horizontal direction and the transform type in the vertical direction. Additionally, 0 indicates DCT2, 1 indicates DST7, and 2 indicates DCT8.

On the other hand, in the implicit MTS, e.g., in the case of an intra block, the transform type may be determined implicitly without explicitly signaling the MTS. In VVC, the transform types in the horizontal and vertical directions may be implicitly determined, as shown in Equation 1.

$$trTypeHor = ( nTbW >= 4 \&\& nTbW <= 16 ) ? DST 7 : DCT 2 \qquad [ Equation 1 ]$$

$$trTypeVer = ( nTbH >= 4 \&\& nTbH <= 16 ) ? DST 7 : DCT 2$$

Here, nTbW and nTbH denote the horizontal and vertical lengths of the transform block, respectively.

As an example, when a particular encoding technique is applied, explicit MTS or implicit MTS may be applied. For example, in the case of Matrix-weighted Intra Prediction (MIP), an explicit intra MTS may be used. In Intra Sub-Partitions (ISP) mode, an implicit intra MTS is used, with DST7 or DCT2 used as the transform type.

If the transform block contains at least one or more non-DC coefficients, mts_idx is signaled. In other words, if the position of the last valid coefficient in the scanning sequence is greater than 0, mts_idx is signaled. On the other hand, if the transform block contains only one non-DC coefficient, signaling of mts_idx is omitted, mts_idx=0 is derived, and DCT2 is applied as the transform kernel.

The first bin of mts_idx that is signaled indicates whether mts_idx is greater than 0. If mts_idx is greater than 0, i.e., mts_idx indicates one of 1 to 4, an additional two bits of fixed length code is signaled to indicate the signaled mts_idx among the four candidates.

Meanwhile, in the next generation of technology, the Enhanced Compression Model (ECM) software, the number and types of MTS kernels are increased, adding DST7, DCT8, DCT5, DST4, DST1, and identity transform.

### II. LOW-FREQUENCY NON-SEPARABLE TRANSFORM (LFNST)

The LFNST technique during intra prediction performs a secondary transform on a low-frequency region of the transform coefficients generated by the primary transform of a transform block (transform unit, TU). On the encoding side, the LFNST technique performs a secondary transform on L low-frequency primary transform coefficients out of W×H primary transform coefficients to generate K (K≤L) secondary transform coefficients. Here, the transform kernel of LFNST is L×K in size. In other words, the LFNST technique represents as a 1×L vector the L low-frequency primary transform coefficients of the W×H primary transform coefficients and then applies the L×K transform kernel to generate a 1×K vector. The LFNST technique then represents the 1×K vector by a two-dimensional array in the low-frequency region for further processing, such as quantization.

Compared to the primary transform, which applies separate transform kernels in the horizontal and vertical directions, the LFNST technique performs a non-separable transform for transforming the one-dimensional vector.

Meanwhile, the type of transform kernel may be determined based on the intra-prediction mode of the current TU, the size of the TU, and the LFNST index (lfnst_idx). For example, based on the intra-prediction mode (IntraPredMode) of the current TU, sets of transform kernels may be determined as shown in Table 2.

TABLE 3

| IntraPredMode | lfnstTrSetIdx |
|---|---|
| IntraPredMode < 0 | 1 |
| 0 ≤ IntraPredMode ≤ 1 | 0 |
| 2 ≤ IntraPredMode ≤ 12 | 1 |
| 13 ≤ IntraPredMode ≤ 23 | 2 |
| 24 ≤ IntraPredMode ≤ 44 | 3 |
| 45 ≤ IntraPredMode ≤ 55 | 2 |
| 56 ≤ IntraPredMode ≤ 80 | 1 |
| 81 ≤ IntraPredMode ≤ 83 | 0 |

Here, the intra-prediction mode (IntraPredMode) is according to the example of FIG. 3B. Further, lfnstTrSetIdx is an index indicating a kernel set. In Table 3, IntraPredMode of 81, 82, and 83 indicate cross-component linear model (CCLM) prediction modes.

For each kernel set (lfnstTrSetIdx), two types of kernels are defined. Which of the two types of kernels is selected may be indicated by the LFNST index. An LFNST index of 0 means that no LFNST is performed, and an LFNST index of 1 or 2 means that different LFNST kernels within the same kernel set are applied. There is one more kernel set depending on the size of the TU, so there are a total of 4×2×2=16 transform kernels. The kernel sizes of LFNST are defined as 16×16 and 16×48. Additionally, depending on the size of the TU, the kernel size may be adjusted as shown in Table 4.

TABLE 4

| Block size | Transform size(K × L) |
|---|---|
| 4 × 4 | 8 × 16 |
| 4 × N, N × 4 (N > 8) | 16 × 16 |
| 8 × 8 | 8 × 48 |
| larger than 8 × 8 | 16 × 48 |

On the other hand, if the DCT2/DCT2 transform kernel is applied as the primary transform for the intra-predicted TU, the LFNST technique may be applied as the secondary transform.

The following embodiments are described with reference to the video decoding device but may be implemented equally or similarly in the video encoding device.

### III. EMBODIMENTS ACCORDING TO THE PRESENT DISCLOSURE

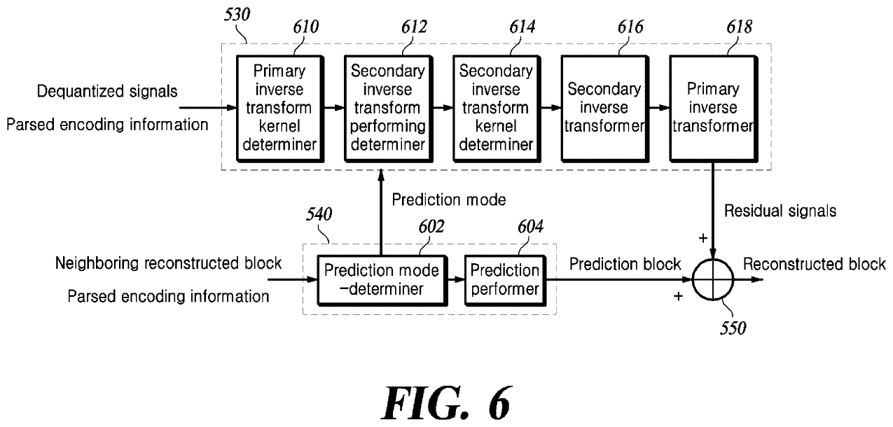

FIG. 6 is a block diagram detailing a portion of a video decoding device, according to at least one embodiment of the present disclosure.

The video decoding device according to some embodiments can determine prediction unit and transform unit, and with respect to a current block corresponding to the determined unit, perform a prediction and an inverse transform by using a determined prediction technique and prediction mode, to finally generate a reconstructed block of the current block. The operations illustrated in FIG. 6 may be performed by an inverse transformer 530, a predictor 540, and an adder 550 of the video decoding device. On the other hand, the same operations as illustrated in FIG. 6 may be performed by the inverse transformer 165, the picture splitter 110, the predictor 120, and the adder 170 of the video encoding device. In this case, the video decoding device uses encoding information parsed from the bitstream, but the video encoding device may use encoding information set from a higher level in terms of minimizing rate distortion. Hereinafter, for convenience, the embodiments are described centering on the video decoding device.

As illustrated in FIG. 5, the predictor 540 includes the intra predictor 542 and the inter predictor 544 according to a prediction technique, while as illustrated in FIG. 6, the predictor 540 may include a prediction mode-determiner 602 and a prediction performer 604.

When the color format of the input video is a YUV format (YUV420, YUV411, YUV422, YUV444, and the like), the video decoding device may perform prediction and reconstruction of the luma component, and then may perform prediction and reconstruction of the chroma component. In other words, the luma component and the chroma component may be sequentially reconstructed by the components illustrated in FIG. 6. Here, in the case of the YUV format, the color format indicates the correspondence between the pixels of the luma component and the pixels of the chroma component.

The prediction mode-determiner 602 determines with respect to the current block a prediction technique, e.g., intra prediction, inter prediction, or intra block copy (IBC) mode, palette mode, etc. The prediction mode-determiner 602 further determines a detailed prediction mode for the prediction technique. The prediction performer 604 generates a prediction block of the current block according to the determined prediction technique and prediction mode.

The inverse transformer 530 inversely transforms the TU represented by the dequantized signals to generate the residual signals.

The adder 550 sums the prediction block and the residual signals to generate a reconstructed block. The reconstructed block is stored in the memory and may be used for subsequent predictions of other blocks.

Hereinafter, the TU is used interchangeably with the transform block.

As shown in the example of FIG. 6, the inverse transformer 530 may include all or part of a primary inverse transform kernel determiner 610, a secondary inverse transform processing determiner 612, a secondary inverse transform kernel determiner 614, a secondary inverse transformer 616, and a primary inverse transformer 618. By using these components, the inverse transformer 530 performs on the transform coefficients in the low-frequency region, a non-separable secondary inverse transform adaptive to the primary transform kernel.

The primary inverse transform kernel determiner 610 may determine the primary inverse transform kernels in the vertical and horizontal directions based on the prediction technique and prediction mode of the current block, the size of the current transform block, mts_idx, and the like, as described above.

The primary inverse transform kernel may be explicitly determined based on the parsed mts_idx. Alternatively, the primary inverse transform kernel may be implicitly determined based on whether or not to transform the subblock, the size of the TU, or the like. In this case, if the current block is predicted according to the intra-prediction mode and the primary inverse transform kernels in the vertical and horizontal directions are explicitly determined according to the parsed mts_idx, the type of kernel indicated by mts_idx may be determined based on the size of the current TU and the intra prediction mode. For example, upon defining the type of one-dimensional inverse transform kernels in the vertical and horizontal directions represented by mts_idx for a combination of possible TU sizes (4×4, 4×8, 8×4, 8×8, . . . ) and intra-prediction modes according to an agreement, the primary inverse transform kernel determiner 610 may parse mts_idx to determine the final inverse transform kernel.

At this point, the intra-prediction mode (IntraPredMode) may be divided into A mode sets centered on the top-left diagonal mode (mode 34). When A=4, based on the example of FIG. 3B, the mode sets are represented as shown in Table 5.

TABLE 5

| IntraPredMode | Mode Set |
|---|---|
| IntraPredMode < 0 | 1 |
| 0 ≤ IntraPredMode ≤ 1 | 0 |
| 2 ≤ IntraPredMode ≤ 12 | 1 |
| 13 ≤ IntraPredMode ≤ 23 | 2 |
| 24 ≤ IntraPredMode ≤ 44 | 3 |
| 45 ≤ IntraPredMode ≤ 55 | 2 |
| 56 ≤ IntraPredMode ≤ 80 | 1 |

The matrix-based prediction mode may be included in the set of nondirectional modes (mode set 0) or may be classified into a separate set. Further, if a chroma block is predicted with an cross-component prediction mode that utilizes a relationship between the chroma component and the luma component, the primary inverse transform kernel determiner 610 maps the intra-prediction mode at the center position of the corresponding luma block to the intra prediction mode of the current chroma block. The primary inverse transform kernel determiner 610 may establish a mode set from the mapped intra-prediction modes based on Table 5, and may use the mode set for determining the primary inverse transform kernel.

If the current block is predicted based on inter prediction, the transform kernel represented by mts_idx according to the TU size may be determined based on an agreement between the video encoding device and the video decoding device. Alternatively, the kernel represented by mts_idx may be fixed.

For example, if the current block is predicted according to the combined inter-intra prediction mode (CIP mode), the primary inverse transform kernel of the current TU may be determined by the same method as determining the kernel of the intra-prediction block according to the intra prediction mode and the TU size. Here, CIP is one example mode in which the final prediction block of the current block is generated by weight summing the prediction block based on the inter prediction and the prediction block based on the intra prediction. Alternatively, if the current block is predicted by the CCIP mode, the primary inverse-transform kernel of the current TU may be determined in the same way as the inter prediction.

Depending on embodiments, if the weight of the intra-prediction block is greater than that of the inter-prediction block, the primary inverse transform kernel of the current TU may be determined in the same way as the intra-prediction. At this time, based on the transform block size and the intra-prediction mode, some of the kernels of DCT-N (N=1, . . . , 8), DST-N, and IDT (Identity Transform) may be selected as the primary inverse transform kernel in the vertical and horizontal directions, respectively. For example, the DCT-2, DCT-5, DCT-8, DST-1, DST-4, DST-7, IDT kernel may be used as the primary inverse transform kernels.

The secondary inverse transform processing determiner 612 may parse a 1-bit flag (lfnst_flag, hereinafter ‘LFNST flag’) or an LFNST index (lfnst_idx) indicating whether or not to apply a secondary inverse transform and thereby determine whether or not to apply the secondary inverse transform. In parsing the LFNST index, it may be arranged in advance that a particular index value (e.g., lfnst_idx=0) indicates no application of the secondary inverse transform.

In one example, the application or non-application of the secondary inverse transform may be implicitly determined by the type of primary transform kernels in the vertical and horizontal directions. If the secondary inverse transform is applied for a particular primary transform kernel, the transmission of LFNST flags or LFNST indices may be omitted. Additionally, the secondary inverse transform may not be implicitly applied for the remaining transform kernels except for the particular primary transform kernel.

The secondary inverse transform kernel determiner 614 may be responsive to the determination of performing the secondary inverse transform for determining a secondary inverse transform kernel based on the size of the current TU, the intra-prediction mode, and the primary inverse transform kernel.

In one example, the size of the secondary inverse transform kernel may depend on a set S of kernel sizes having C different sizes based on the size of the TU.

For example, the size of the kernel may be determined based on the following conditions (size of the TU), and the criteria for distinguishing the set may vary according to embodiments.

### Embodiment 1

S₀: 4×N/N×4 (N≥4), S₁: 8×N/N×8 (N≥8), S₂: M×N (M,N≥16)

### Embodiment 2

S₀: 4×4, S₁: 4×N/N×4 (N≥8), S₂: 8×8, S₃: M×N (except M,N≥8, M=N=8)

The inverse transform kernel of each set has a size of pᵢ×qᵢ(0≤i<C). Here, pᵢ means the size of the outputted primary transform coefficients, qᵢ means the size of the inputted secondary transform coefficients, and pᵢ≥qᵢ.

As described above, with respect to the set S of kernel sizes determined by the TU size, there may be A (sets of intra-prediction modes)×K (sets of primary transform kernels)=T sets of secondary inverse transform kernels (or ‘kernel sets’) based on the intra prediction mode and the type of primary transform kernel in the current block.

The intra-prediction modes may be classified into A mode sets centered on the top-left diagonal mode, as shown in one example in Table 5. The matrix-based prediction modes may be included in the non-directional mode set (mode set 0) or may be classified into a separate set. Further, if a chroma block is predicted based on an cross-component prediction (e.g., CCLM mode) that utilizes a relationship between the chroma component and luma component to make the prediction, the secondary inverse transform kernel determiner 614 maps the intra-prediction mode at the center location of the corresponding luma block to the intra prediction mode of the current chroma block. The secondary inverse transform kernel determiner 614 may establish a mode set from the mapped intra-prediction modes based on Table 5, and may use the mode set to determine the secondary inverse transform kernel.

Depending on embodiments, K {vertical, horizontal}sets of kernels may be categorized according to the type of primary transform/inverse transform kernel. The kernel sets may be categorized as follows, and the criteria for classifying the sets may vary by embodiments.

### Embodiment 1

S₀: {DCT-2, DCT-2}, S₁: {DCT-2, IDT}, S₂: {IDT, DCT-2}

### Embodiment 2

S₀: {DCT-2, DCT-2}, S₁: the other kernels

### Embodiment 3

S₀: {DCT-2, DCT-2}, S₁: {DST-7, DST-7}, S₂: the other kernels

### Embodiment 4

S₀: {DCT-2, DCT-2}, S₁: {DST-N, DCT-M}, {DCT-M, DST-N},
S₂: {DCT-N, IDT}, {IDT, DCT-N}, S₃: the other kernels,
N, M={1 and/or 2 and/or, . . . , 8}

### Embodiment 5

S₀: {DCT-2, DCT-2}, S₁: {DST-7, DST-7}, S₂: {DCT-N, IDT}, {IDT, DCT-N},
S₃: {DST-N, IDT}, {IDT, DST-N}, S₄: the other kernels,
N={1 and/or 2 and/or, . . . , 8}

Here, the other kernels may be combinations of primary transform kernels that are not included in the previous set among combinations of primary kernels that are subjected to the secondary transform/inverse transform.

The C×T sets of secondary kernels determined based on the TU size, the intra-prediction mode, and the primary inverse transform kernel may include one or multiple secondary inverse transform kernels. If multiple kernels are included, secondary inverse transform kernel determiner 614 may parse the LFNST index and may determine, based on the parsed LFNST index, secondary inverse transform kernels in the current set of kernels. Thus, as described above, transmission of the LFNST index may not be omitted when a secondary inverse transform is applied for a particular primary transform kernel, but when the kernel set includes multiple secondary inverse transform kernels.

In this case, the LFNST index being 0 means that the secondary inverse transform is not performed, and if lfnst_idx≥1, the secondary inverse transform may be applied based on the LFNST index.

Meanwhile, the entropy decoder 510 may reconstruct the quantized secondary transform coefficients when the secondary inverse transform is applied. Alternatively, the entropy decoder 510 may reconstruct the quantized primary transform coefficient when the secondary inverse transform is not applied. In this case, both the secondary transform coefficient and the primary transform coefficient are data in the form of a two-dimensional matrix.

The secondary inverse transformer 616 receives the dequantized secondary transform coefficient and applies the secondary inverse transform kernel to reconstruct the primary transform coefficient.

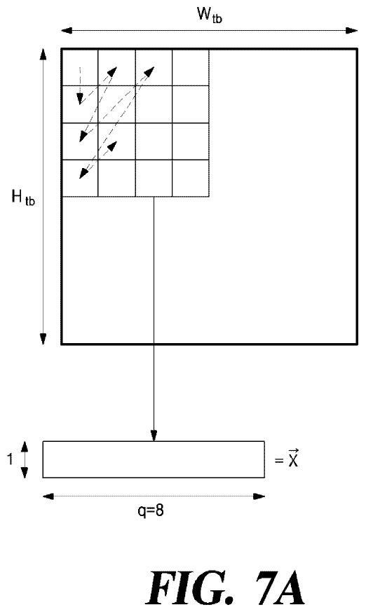

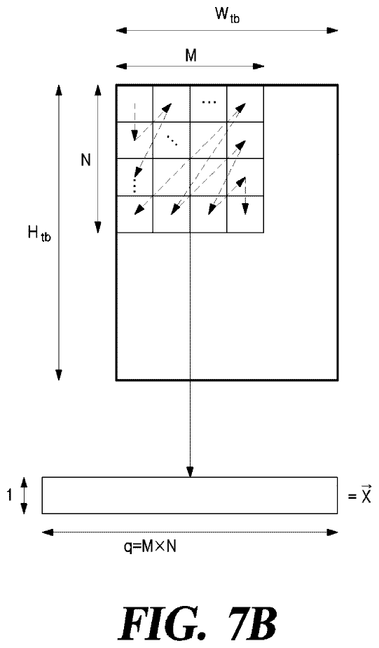

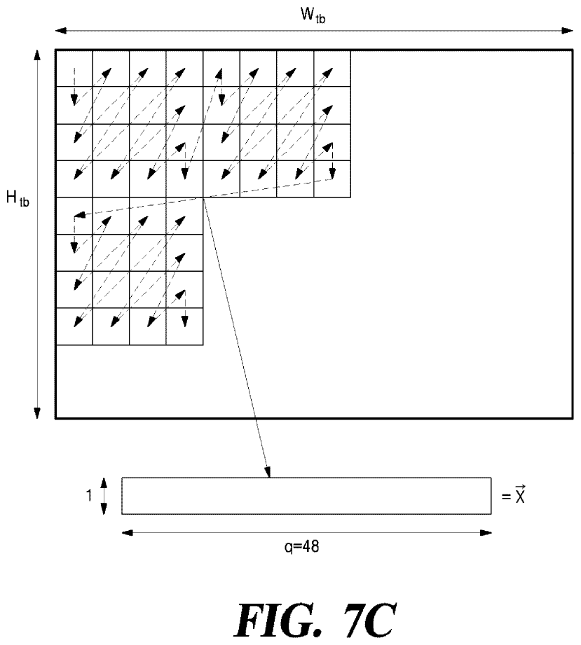

Based on the size and type of the secondary inverse transform kernel, the secondary inverse transformer 616 may generate a secondary transform coefficient vector (\vec{X}) by packing the ‘q’ reconstructed secondary transform coefficients in one dimension according to a scanning sequence. Here, the scanning sequence may be prearranged between the video encoding device and the video decoding device. For example, if the size ‘q’ of the secondary inverse transform coefficients is 8 (FIG. 7A), M×N (FIG. 7B), or 48 (FIG. 7C), the secondary transform coefficient vector may be generated as shown in the exemplary scanning sequences of FIGS. 7A to 7C. Depending on embodiments, the scanning for generating the secondary transform coefficient vector may be performed in reverse order.

In the example of FIG. 7B, if the size of the secondary transform coefficient vector is 16, M=N=4, and if the size of the secondary transform coefficient vector is 32, M=8, N=4, or M=4, N=8.

In the examples of FIGS. 7A through 7C, W_{tb} denotes the width of the transform block and H_{tb} denotes the height of the transform block.

The secondary inverse transformer 616 performs an inverse transform by using a matrix product between a secondary transform coefficient vector of size ‘q’ and a secondary inverse transform kernel F of size p×q. The secondary inverse transformer 616 may perform a secondary inverse transform to generate a primary transform coefficient vector (\vec{Y}) of size ‘p’, as shown in Equation 2.

$$\vec{Y} = F \cdot \vec{X} \qquad [ Equation 2 ]$$

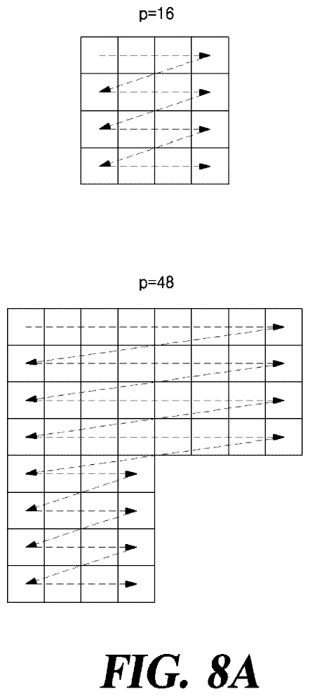

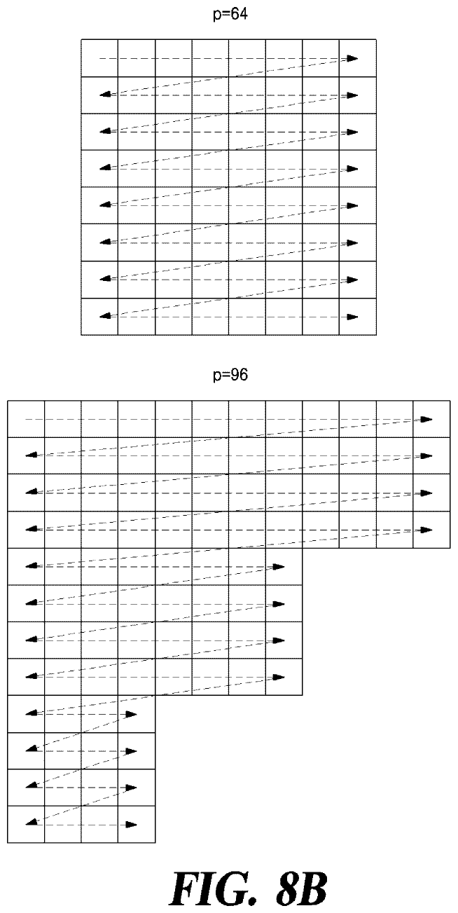

The secondary inverse transformer 616 may generate a two-dimensional matrix based on the size of the current TU from the primary transform coefficient vector generated according to the secondary inverse transform. As shown in the example of FIGS. 8A to 8B, based on the size ‘p’ of the primary transform coefficient vector, the primary transform coefficients may be assigned following the scanning sequence to the top-left side of the TU. Depending on the video encoding device's scanning sequence on the primary transform coefficients for the secondary transform, the scanning sequence utilized by the secondary inverse transformer 616 may vary.

At this time, the video decoding device may derive as zero the transform coefficients of the remaining TU regions where the primary transform coefficients are not present.

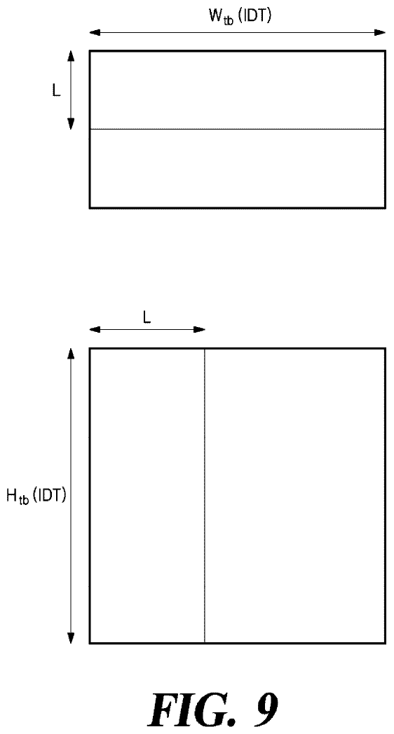

In one example, when the IDT (Identity Transform) is applied as a primary transform kernel to either the vertical or horizontal direction, the secondary inverse transformer 616 may assign primary transform coefficients by taking into account the direction in which the IDT is applied. The secondary inverse transformer 616 may use the primary transform coefficient vector to assign a number ‘p’ of primary transform coefficients to the region illustrated in FIG. 9 according to a scanning sequence. Here, the scanning sequence may be preset according to an arrangement between the video encoding device and the video decoding device. When the transform of IDT is applied in the horizontal direction, p=W_{tb}×L, and when the IDT is performed in the vertical direction, p=L×H_{tb}. In this case, the magnitude of ‘p’ may be defined according to the secondary inverse transform kernel determined in secondary inverse transform kernel determiner 614. In the example of FIG. 9, the video decoding device may derive as zero the transform coefficients of the remaining TU regions where the ‘p’ primary transform coefficients are not present.

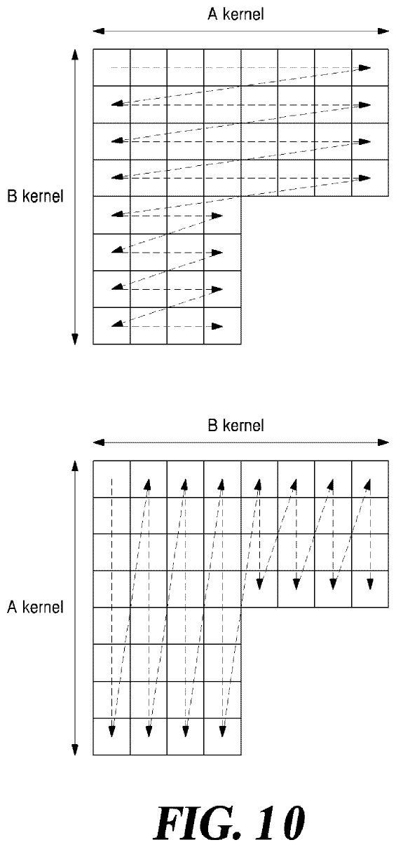

As another example, if the primary transform kernels in the vertical direction are different from those in the horizontal direction, a scanning sequence for assigning the primary transform coefficient vector within the TU may be determined based on the type of kernels in the vertical direction and the type of kernels in the horizontal direction. If the same secondary transform kernel is applied for a block with a B kernel applied in the vertical direction and an A kernel applied in the horizontal direction, and if the same secondary transform kernel is applied for a block with an A kernel applied in the vertical direction and a B kernel applied in the horizontal direction, the secondary inverse transformer 616 may map the primary transform coefficient vectors to the transform coefficients of the TU blocks by scanning the specific kernel direction first, as shown in the example of FIG. 10.

The primary inverse transformer 618 may perform a primary inverse transform in the vertical and horizontal directions by using the primary inverse transform kernel determined in the primary inverse transform kernel determiner 610 with respect to the primary transform coefficients assigned as pixel values of the TU block according to the secondary inverse transform.

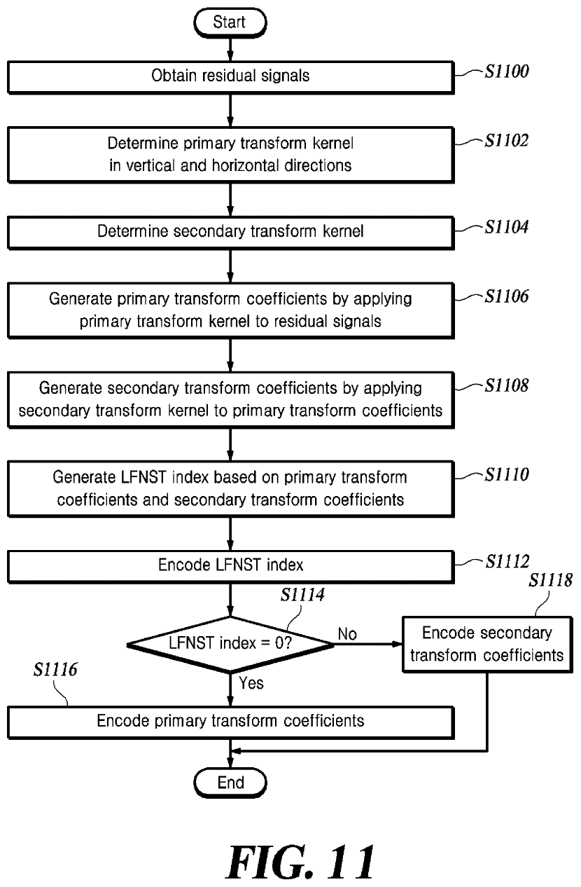

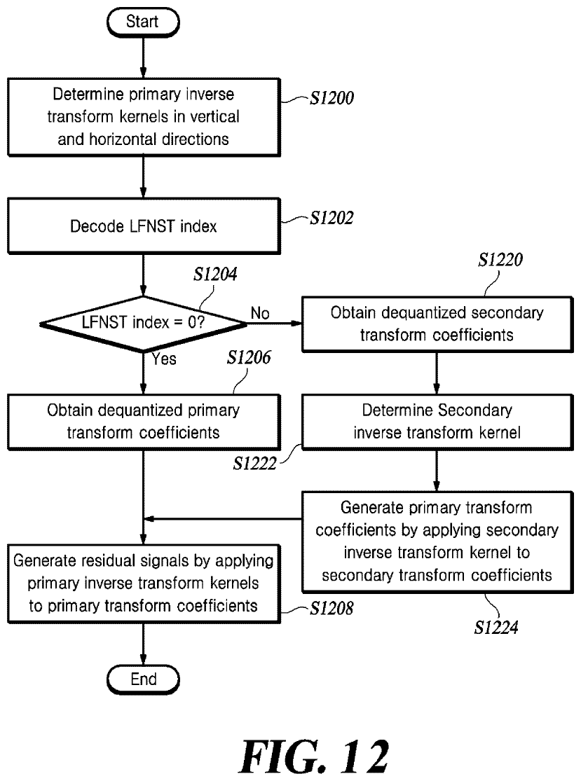

Referring now to FIGS. 11 and 12, methods of transforming and inverse transforming a transform block of the current block are described.

FIG. 11 is a flowchart of a method of transforming a transform block by the video encoding device, according to another embodiment of the present disclosure.

The video encoding device obtains residual signals for the transform block of the current block (S1100).

The video encoding device determines a primary transform kernel in the vertical and horizontal directions for the transform block (S1102).

The video encoding device determines a secondary transform kernel of the transform block based on the size of the transform block, the intra-prediction mode of the current block, and the primary transform kernel (S1104).

The video encoding device selects, from among preset mode sets, a mode set that includes the intra-prediction mode of the current block. The video encoding device selects, from among preset primary kernel sets, a primary kernel set that includes the primary transform kernel. The video encoding device selects a kernel size set that includes the size of the transform block from among a set of preset kernel sizes. The video encoding device selects a set of secondary kernels according to the selected mode set, the selected primary kernel set, and the selected kernel size set.

If the set of secondary kernels includes a single secondary kernel, the video encoding device sets the secondary transform kernel to be the single secondary kernel. If the set of secondary kernels includes a plurality of secondary kernels, the video encoding device may set the secondary transform kernel to be one of the plurality of secondary kernels.

The video encoding device performs a primary transform by applying the primary transform kernel to the residual signals to generate primary transform coefficients (S1106).

The video encoding device performs a secondary transform by applying the secondary transform kernel to the primary transform coefficients to generate secondary transform coefficients (S1108).

Based on the size and type of the secondary transform kernel, the video encoding device generates a primary transform coefficient vector by packing a portion of the primary transform coefficients in one dimension according to a preset scanning sequence. The video encoding device performs a matrix product between the primary transform coefficient vector and the secondary transform kernel to generate the secondary transform coefficient vector. The video decoding device may generate the secondary transform coefficients by assigning the secondary transform coefficient vector according to the scanning sequence preset in the top-left of the transform block.

Based on the primary transform coefficients and the secondary transform coefficients, the video encoding device determines an LFNST index (S1110). Here, the LFNST index indicates whether the secondary transform is applied.

In terms of rate-distortion optimization, the video encoding device may determine the value of the LFNST index. For example, if the primary transform coefficients are optimal, the video encoding device may set the LFNST index to 0. On the other hand, if the secondary transform coefficients are optimal, the video encoding device may set the LFNST index according to the number of secondary kernels that the above-described set of secondary kernels includes. If the set of secondary kernels includes a single secondary kernel, the video encoding device may set the LFNST index to 1. If the set of secondary kernels includes multiple secondary kernels, the video encoding device may set the LFNST index to indicate one of the multiple secondary kernels.

The video encoding device encodes the LFNST index (S1112).

The video encoding device checks the LFNST index (S1114).

If the LFNST index is 0 (Yes in S1114), the video encoding device encodes the primary transform coefficients (S1116). The video encoding device may quantize and entropy encode the primary transform coefficients to generate a bitstream of the primary transform coefficients.

On the other hand, if the LFNST index is greater than 0 (No in S1114), the video encoding device encodes the secondary transform coefficients (S1118). The video encoding device may quantize and entropy encode the secondary transform coefficients to generate a bitstream of the secondary transform coefficients.

FIG. 12 is a flowchart of a method of inversely transforming a transform block by the video decoding device, according to at least one embodiment of the present disclosure.

The video decoding device determines primary inverse transform kernels in the vertical and horizontal directions for the transform block of the current block (S1200).

The video decoding device decodes the LFNST index from the bitstream (S1202). Here, the LFNST index indicates whether a secondary inverse transform is applied.

The video decoding device checks the LFNST index (S1204).

If the LFNST index is 0 (Yes in S1204), the video decoding device performs the following steps (S1206 and S1208).

The video decoding device obtains the dequantized primary transform coefficients for the transform block (S1206).

The video decoding device performs a primary inverse transform by applying the primary inverse transform kernel to the primary transform coefficients to generate residual signals (S1208).

If the LFNST index is greater than 0 (No in S1204), the video decoding device performs the following steps (S1220 through S1224, S1208).

The video decoding device obtains the dequantized secondary transform coefficients for the transform block (S1220).

The video decoding device determines a secondary inverse transform kernel of the transform block based on the size of the transform block, the intra-prediction mode of the current block, and the primary inverse transform kernel (S1222).

The video decoding device selects, from among the preset sets of modes, a mode set that includes the intra-prediction mode of the current block. The video decoding device selects, from among the preset sets of primary kernels, a primary kernel set that includes the primary inverse transform kernel. The video decoding device selects a kernel size set that includes the size of the transform block from among the preset kernel size sets. The video decoding device selects a set of secondary kernels according to the selected mode set, the selected primary kernel set, and the selected kernel size set.

If the set of secondary kernels includes one secondary kernel, the video decoding device sets the secondary transform kernel to be the one secondary kernel. In this case, the LFNST index may be decoded as 1. If the set of secondary kernels includes multiple secondary kernels, the video decoding device may set the secondary transform kernel to the secondary kernel indicated by the LFNST index.

The video decoding device performs a secondary inverse transform by applying the secondary inverse transform kernel to the secondary transform coefficients to generate the primary transform coefficients (S1224).

Based on the size and type of the secondary inverse transform kernel, the video decoding device generates a secondary transform coefficient vector by packing a portion of the secondary transform coefficients in one dimension according to a preset scanning sequence. The video decoding device performs a matrix product between the secondary transform coefficient vector and the secondary inverse transform kernel to generate a primary transform coefficient vector. The video decoding device may generate the primary transform coefficients by assigning the primary transform coefficient vector according to a scanning sequence preset in the top-left of the transform block.

The video decoding device performs a primary inverse transform by applying the primary inverse transform kernel to the primary transform coefficients to generate residual signals (S1208).

The video decoding device may then sum the residual signals and the prediction block of the current block to generate a reconstructed block of the current block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

140: transformer
165: inverse transformer
530: inverse transformer
610: primary inverse transform kernel determiner
612: secondary inverse transform performing determiner
614: secondary inverse transform kernel determiner
616: secondary inverse transformer
618: primary inverse transformer

### CROSS-REFERENCE TO RELATED APPLICATIONS

This application claims priority to and the benefit of Korean Patent Application No. 10-2022-0108550 filed on Aug. 29, 2022, and Korean Patent Application No. 10-2023-0097617, filed on Jul. 26, 2023, the entire contents of each of which are incorporated herein by reference.

What is claimed is:

1. A method of reconstructing a current block by a video decoding device, the method comprising:
determining primary inverse transform kernels in vertical and horizontal directions with respect to a transform block of the current block;
obtaining dequantized secondary transform coefficients for the transform block;
determining a secondary inverse transform kernel of the transform block based on a size of the transform block, an intra-prediction mode of the current block, and the primary inverse transform kernel;
performing a secondary inverse transform by generating primary transform coefficients by applying the secondary inverse transform kernel to the secondary transform coefficients; and
performing a primary inverse transform by generating residual signals by applying the primary inverse transform kernels to the primary transform coefficients.

2. The method of claim 1, further comprising:
decoding, from a bitstream, a low frequency non-separable transform index (LFNST index) that indicates whether a secondary inverse transform is to be applied; and
checking the LFNST index,
wherein, if the LFNST index is greater than 0, processing obtaining the secondary transform coefficients through performing the primary inverse transform.

3. The method of claim 2, further comprising, when the LFNST index is 0:
obtaining dequantized primary transform coefficients for the transform block; and
processing determining the primary inverse transform kernels and performing the primary inverse transform.

4. The method of claim 1, wherein determining the primary inverse transform kernels comprises:
decoding an index indicating the primary inverse transform kernels; and
setting the primary inverse transform kernels according to the index.

5. The method of claim 4, wherein the primary inverse transform kernels are characterized in that a kind of transform kernels indicated by the index is predefined based on the intra-prediction mode of the current block and the size of the transform block.

6. The method of claim 2, wherein determining the secondary inverse transform kernel comprises:
selecting, among preset sets of modes, a set of modes that include the intra-prediction mode of the current block; and
selecting, among preset sets of primary kernels, a set of primary kernels that include the primary inverse transform kernels.

7. The method of claim 6, wherein determining the secondary inverse transform kernel further comprises:
selecting, from preset sets of kernel sizes, a set of kernel sizes that include the size of the transform block; and
selecting a secondary kernel set according to the selected set of modes, the selected set of primary kernels, and the selected set of kernel sizes.

8. The method of claim 7, wherein determining the secondary inverse transform kernel comprises:
when the secondary kernel set comprises a single secondary kernel, setting the secondary inverse transform kernel by the single secondary kernel.

9. The method of claim 7, wherein determining the secondary inverse transform kernel comprises:
when the secondary kernel set comprises a plurality of secondary kernels, setting the secondary inverse transform kernel by a secondary kernel indicated by the LFNST index.

10. The method of claim 1, wherein performing the secondary inverse transform comprises:
generating a secondary transform coefficient vector by one-dimensionally packing a portion of the secondary transform coefficients according to a preset first scanning sequence, based on a size and a type of the secondary inverse transform kernel;
generating a primary transform coefficient vector by performing a matrix product between the secondary transform coefficient vector and the secondary inverse transform kernel; and
generating the primary transform coefficients by assigning the primary transform coefficient vector according to a second scanning sequence preset at a top-left of the transform block.

11. The method of claim 10, wherein generating the primary transform coefficients comprises:
when an identity transform (IDT) is applied as the primary inverse transform kernel in a horizontal or vertical direction with respect to the transform block, assigning the primary transform coefficient vector by taking into account a direction of the applying of the IDT.

12. The method of claim 10, wherein generating the primary transform coefficients comprises:
assigning the primary transform coefficient vector with respect to the transform block by first scanning a direction of a particular primary inverse transform kernel when the primary inverse transform kernel differs by each of the vertical and horizontal directions.

13. A method of encoding a current block by a video encoding device, the method comprising:
obtaining residual signals with respect to a transform block of the current block;
determining a primary transform kernel in vertical and horizontal directions with respect to the transform block;
determining a secondary transform kernel of the transform block based on a size of the transform block, an intra-prediction mode of the current block, and the primary inver-se transform kernel;
performing a primary transform by generating primary transform coefficients by applying the primary transform kernel to the residual signals; and
performing a secondary transform by generating secondary transform coefficients by applying the secondary transform kernel to the primary transform coefficients.

14. The method of claim 12, further comprising:
determining, based on the primary transform coefficients and the secondary transform coefficients, a low frequency non-separable transform index (LFNST index) that indicates whether or not to apply a secondary transform; and
encoding the LFNST index.

15. The method of claim 14, further comprising:
checking the LFNST index; and
encoding the primary transform coefficients when the LFNST index is 0, and encoding the secondary transform coefficients when the LFNST index is greater than 0.

16. A computer-readable recording medium storing a bitstream generated by a video encoding method, the video encoding method comprises:
obtaining residual signals with respect to a transform block of a current block;
determining a primary transform kernel in vertical and horizontal directions with respect to the transform block;
determining a secondary transform kernel of the transform block based on a size of the transform block, an intra-prediction mode of the current block, and the primary transform kernel;
performing a primary transform by generating primary transform coefficients by applying the primary transform kernel to the residual signals; and
performing a secondary transform by generating secondary transform coefficients by applying the secondary transform kernel to the primary transform coefficients.
